(19) United States
(12) Patent Application Publication
(10) Pub. No.: US 2026/0170502 A1
(43) Pub. Date: Jun. 18, 2026

(54) METHOD AND SYSTEM FOR BLOCKING FRAUDULENT TRANSACTIONS USING PREDICTIVE MODELING

(71) Applicant: JPMorgan Chase Bank, N.A., New York, NY (US)

(72) Inventors: Raghavendra BOYA, Bengaluru (IN); Ravi TEJ, Kothapalle Cuddapah (IN); Shrirama A S, Puttur (IN); Hari UTTERPALLY, Sangareddy (IN); Sourav MAHATO, Purulia (IN)

(73) Assignee: JPMorgan Chase Bank, N.A., New York, NY (US)

(21) Appl. No.: 19/073,785

(22) Filed: Mar. 7, 2025

(30) Foreign Application Priority Data
Dec. 13, 2024 (IN) 202411098920

(51) Int. Cl. G06Q 20/40; G06F 16/215; G06F 16/2455

(52) U.S. Cl. CPC G06Q 20/4016; G06F 16/215; G06F 16/24568

(57) ABSTRACT

A method and system for blocking fraudulent transactions using predictive modeling is provided. The method includes: collecting a set of data streams associated with a transaction initiated by a first entity; storing, by the at least one processor, the set of data streams into a database; pre-processing the set of data streams; identifying a trained model to analyze the transaction; determining, using the identified trained model, a fraud score based on the processed set of data streams, the fraud score reflecting a probability that the transaction is fraudulent; estimating, using the identified trained model, a degree of risk based on the fraud score for the transaction; and blocking the transaction based on at least a result of the estimating.

### CROSS-REFERENCE TO RELATED APPLICATIONS

This application claims priority benefit from Indian Application No. 202411098920, filed on Dec. 13, 2024 in the India Patent Office, which is hereby incorporated by reference in its entirety.

### FIELD OF THE DISCLOSURE

This technology generally relates to the field of machine learning based prediction of fraudulent transactions, and more particularly relates to methods and systems for blocking fraudulent transactions using predictive modeling.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In today's digital economy, the proliferation of online transactions has transformed the landscape of financial services, enabling consumers to perform transactions conveniently from anywhere in the world. However, this convenience has also given rise to an increase in fraudulent activities which pose significant risks to financial institutions and consumers alike. All the financial institutions globally pose the threat of financial risks and operational challenges due to the exponential increase of fraudulent activities and are finding it hard to combat them.

The growing sophistication of fraud techniques necessitates the development of advanced fraud detection systems capable of accurately identifying and mitigating fraudulent transactions in real-time. Traditional fraud detection methods often rely on rule-based systems that use predefined thresholds and heuristics to identify anomalies. The traditional fraud detection techniques used currently are often found to be insignificant and inadequate to help address the sophisticated complex fraud schemes mainly because of the manual processing limitations and data scope constraints. This proves to be the need to have a fraud detection system that is capable of providing a comprehensive real-time adaptive solution which in turn will result in protecting the financial assets of the institution as well as the end customers.

The above traditional methods present technical problems. Lower accuracy fraud detection methodologies increase both the amount of allowed fraudulent transactions and the number of false positives. Both scenarios require additional computer resources and electrical power to correct. Electrical power demands for such data operations are an industry wide problem, as illustrated by Microsoft recently leasing a nuclear power plant to provide electricity for its data processing operations. There is a need for higher accuracy fraud detection methodologies with lower electrical power and computer processing requirements for corrective efforts.

Hence, in light of these and other existing limitations, there arises an imperative need to provide an efficient solution to overcome the above-mentioned limitations and to provide a method and system that can predict the severity of potential fraudulent transactions in real time.

### SUMMARY

The present disclosure, through one or more of its various aspects, embodiments, and/or specific features or sub-components, provides, inter alias, various systems, servers, devices, methods, media, programs, and platforms for blocking fraudulent transactions using predictive modeling.

According to an embodiment of the invention, a method for blocking fraudulent transactions using predictive modeling, the method being implemented by at least one processor, is provided. The method includes: collecting, by the at least one processor, a set of data streams associated with a transaction initiated by a first entity; storing, by the at least one processor, the set of data streams into a database; pre-processing, by the at least one processor, the set of data streams; identifying a trained model to analyze the transaction; determining, by the at least one processor using the identified trained model, a fraud score based on the processed set of data streams, the fraud score reflecting a probability that the transaction is fraudulent; estimating, by the at least one processor using the identified trained model, a degree of risk based on the fraud score for the transaction; and blocking the transaction based on at least a result of the estimating.

The above embodiment may have various features. The method may include sending, by the at least one processor, at least one recommendation based on the estimated degree of risk to a user equipment associated with the first entity. The at least one recommendation may be at least one from among an alert corresponding to the estimated degree of risk and an actionable insight for the transaction. The method may include receiving, by the at least one processor, a feedback in response to the at least one recommendation from at least one of: the first entity and a second entity. The set of data streams may include at least one from among user profile details, behavioral data, transactional data, biometrics data, communication data, contextual data, device data attributes, historical data attributes, external data attributes, anomaly detection attributes, and/or financial data attributes. The pre-processing may include: complying the set of data streams with data cleansing process and data enrichment process; performing data encryption processes on the set of data streams; and applying predefined rules over the set of data streams for anomaly detection. The method may include training the identified trained model to detect a fraudulent transaction, including: creating, by the at least one processor, at least one training dataset and at least one validation dataset from the set of data streams; and retrieving, by the at least one processor, a set of attributes for the transaction from the at least one training dataset and the at least one validation dataset to train the identified trained model.

According to another embodiment of the invention, a computing device programmed to block fraudulent transactions using predictive modeling is provided. The computing device includes a processor and a memory storing instructions programmed to cooperate with the processor to cause the processor to perform operations. The operations include: collect a set of data streams associated with a transaction initiated by a first entity; store the set of data streams into a database; pre-process the set of data streams; identify a trained model to analyze the transaction; determine, using the identified trained model, a fraud score based on the processed set of data streams, the fraud score reflecting a probability that the transaction is fraudulent; estimate, using the trained model, a degree of risk based on the fraud score for the transaction; and block the transaction based on at least a result of the estimating.

The above embodiment may have various features. The operations may include send at least one recommendation based on the estimated degree of risk to a user equipment associated with the first entity. The at least one recommendation may include at least one from among an alert corresponds to the estimated degree of risk and an actionable insight for the transaction. The operations may include receive a feedback in response to the at least one recommendation from at least one of: the first entity and a second entity. The set of data streams may include at least one from among user profile details, behavioral data, transactional data, biometrics data, communication data, contextual data, device data attributes, historical data attributes, external data attributes, anomaly detection attributes, and financial data attributes. The pre-process may include: complying the set of data streams with data cleansing process and data enrichment process; performing data encryption processes on the set of data streams; and applying predefined rules over the set of data streams for anomaly detection. The operations may include training the identified trained model, including: create at least one training dataset and at least one validation dataset from the set of data streams; and retrieve a set of attributes for the transaction from the at least one training dataset and the at least one validation dataset to train the identified trained model.

According to another embodiment, a non-transitory computer readable storage medium stores instructions for blocking fraudulent transactions using predictive modeling is provided. The storage medium includes executable code which, when executed by a processor, causes the processor to perform operations. The operations includes: collect a set of data streams associated with a transaction initiated by a first entity; store the set of data streams into a database; pre-process the set of data streams; identify a trained model to analyze the transaction; determine, using the identified trained model, a fraud score based on the processed set of data streams, the fraud score reflecting a probability that the transaction is fraudulent; estimate, using the identified trained model, a degree of risk based on the fraud score for the transaction; and block the transaction based on at least a result of the estimating.

The above embodiment may have optional features. The operations may include send at least one recommendation based on the estimated degree of risk to a user equipment associated with the first entity. The at least one recommendation comprises at least one from among an alert corresponds to the estimated degree of risk and an actionable insight for the transaction. The operations may include receive a feedback in response to the at least one recommendation from at least one of: the first entity and a second entity. The operations may include receive a feedback in response to the at least one recommendation from at least one of: the first entity and a second entity. The set of data streams may include at least one from among user profile details, behavioral data, transactional data, biometrics data, communication data, contextual data, device data attributes, historical data attributes, external data attributes, anomaly detection attributes, and financial data attributes.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system to block fraudulent transactions using predictive modeling, in accordance with an exemplary embodiment of the present disclosure.

FIG. 2 illustrates an exemplary diagram of a network environment to block fraudulent transactions using predictive modeling, in accordance with an exemplary embodiment of the present disclosure.

FIG. 3 illustrates a system diagram to block fraudulent transactions using predictive modeling, in accordance with an exemplary embodiment of the present disclosure.

FIG. 4 illustrates an exemplary method flow diagram for blocking fraudulent transactions using predictive modeling, in accordance with an exemplary embodiment of the present disclosure.

FIG. 5 illustrates a block diagram representing a system to block fraudulent transactions using predictive modeling, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skills in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Furthermore, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

Existing systems or solutions fail to identify potential fraudulent transactions in real time. Additionally, the existing solutions are unable to predict the severity of fraudulent transactions which may lead to huge financial losses to an individual or an organization. The traditional fraud detection techniques are often found to be insignificant and inadequate to help address the sophisticated complex fraud schemes mainly because of the manual processing limitations and data scope constraints. This proves to be the need to have a fraud detection system that is capable of providing a comprehensive real-time adaptive solution which in turn will result in protecting the financial assets of the institution as well as the end customers.

To overcome the above-mentioned problems, the present disclosure provides a method and system for blocking fraudulent transactions using predictive modeling. In the present disclosure, a method for blocking fraudulent transactions using predictive modeling, the method being implemented by at least one processor, is provided. The method includes: collecting, by the at least one processor, a set of data streams associated with a transaction initiated by a first entity; storing, by the at least one processor, the set of data streams into a database; pre-processing, by the at least one processor, the set of data streams; identifying a trained model to analyze the transaction; determining, by the at least one processor using the identified trained model, a fraud score based on the processed set of data streams, the fraud score reflecting a probability that the transaction is fraudulent; estimating, by the at least one processor using the identified trained model, a degree of risk based on the fraud score for the transaction; and blocking the transaction based on at least a result of the estimating.

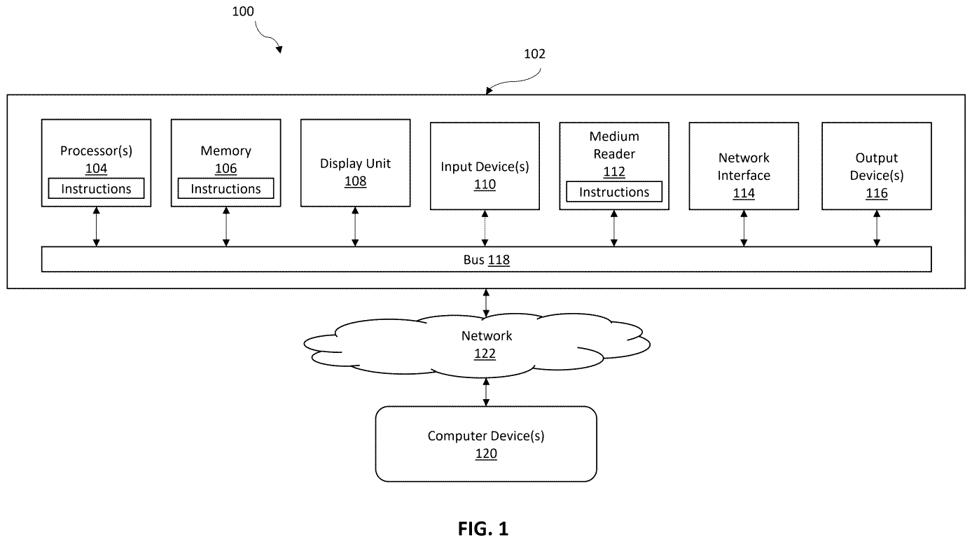

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for blocking fraudulent transactions using predictive modeling.

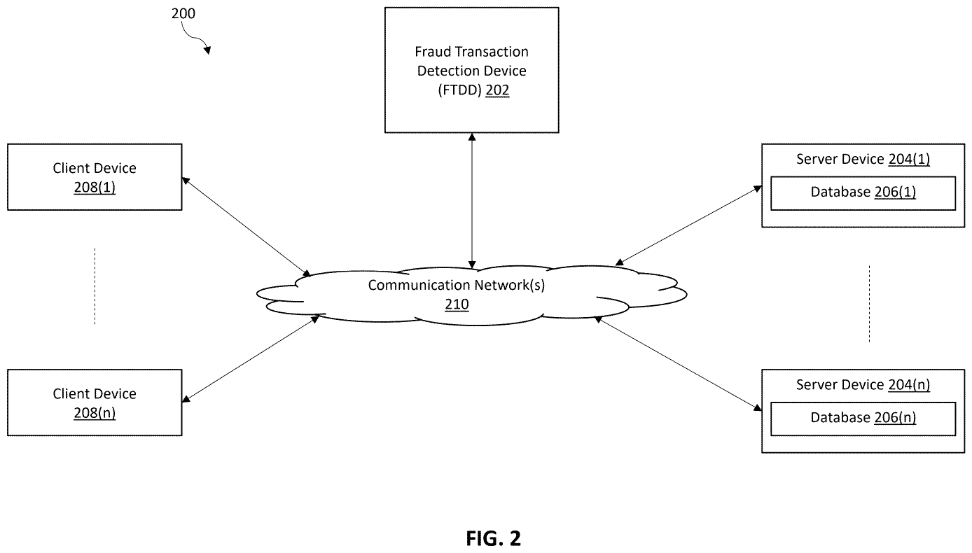

Referring to FIG. 2, a schematic of an exemplary network environment 200 for blocking fraudulent transactions using predictive modeling is illustrated. In an exemplary implementation, the method is executable on any networked computer platform, such as, for example, a personal computer (PC).

The method for blocking fraudulent transactions using predictive modeling may be executed by a fraud transaction detection device (FTDD) 202. The FTDD 202 may be the same or similar to the computer system 102 as described with respect to FIG. 1. The FTDD 202 may store one or more applications that may include executable instructions that, when executed by the FTDD 202, cause the FTDD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the FTDD 202 itself, may be located in the virtual server(s) running in a cloud-based computing environment rather than being tied to one or more specific physical network computing devices. Also, the application(s) may be running in one or more virtual machines (VMs) executing on the FTDD 202. Additionally, in one or more embodiments of this technology, virtual machine(s) running on the FTDD 202 may be managed or supervised by a hypervisor.

In the network environment 200 of FIG. 2, the FTDD 202 is coupled to a plurality of server devices 204(1)-204(n) that hosts a plurality of databases 206(1)-206(n), and also to a plurality of client devices 208(1)-208(n) via communication network(s) 210. A communication interface of the FTDD 202, such as the network interface 114 of the computer system 102 of FIG. 1, operatively couples and communicates between the FTDD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the FTDD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and FTDDs that efficiently implement the method for blocking fraudulent transactions using predictive modeling.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The FTDD 202 may be a standalone device or integrated with one or more other devices or apparatuses, such as one or more of the server devices 204(1)-204(n), for example. In one particular example, the FTDD 202 may include or be hosted by one of the server devices 204(1)-204(n), and other arrangements are also possible. Moreover, one or more of the devices of the FTDD 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the FTDD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store a set of data streams, processed set of data streams, feedbacks received from at least one of a first entity and a second entity, for implementation of the features of the present disclosure.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the FTDD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary implementation, at one client device 208 is a wireless mobile communication device, e.g., a smartphone.

The client devices 208(1)-208(n) may run interface applications, such as standard web browsers or standalone client applications, which may provide an interface to communicate with the FTDD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the FTDD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the FTDD 202, the server devices 204(1)-204(n), or the client devices 208(1)-208(n), for example, may be configured to operate as virtual instances on the same physical machine. In other words, one or more of the FTDD 202, the server devices 204(1)-204(n), or the client devices 208(1)-208(n) may operate on the same physical device rather than as separate devices communicating through communication network(s) 210. Additionally, there may be more or fewer FTDDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

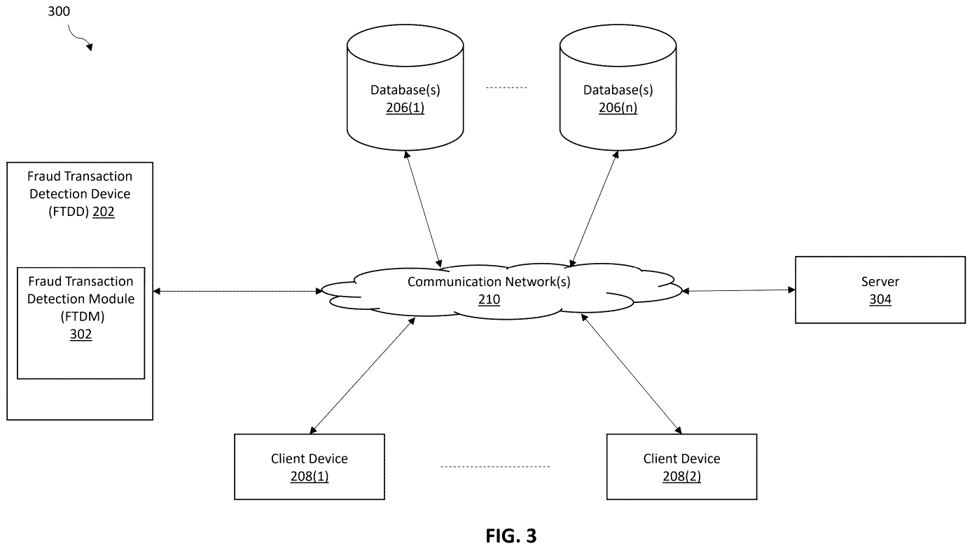

FIG. 3 illustrates a system diagram to block fraudulent transactions using predictive modeling, in accordance with an exemplary embodiment.

As illustrated in FIG. 3, the system 300 may include a fraud transaction detection device (FTDD) 202 within which a fraud transaction detection module (FTDM) 302 is embedded, a server 304, a database(s) 206(1) . . . 206(n), a plurality of client devices 208(1) . . . 208(2), and a communication network(s) 210.

According to exemplary embodiments, the system 300 may comprise the FTDD 202 including the FTDM 302 may be connected to the server 304 and the database(s) 206(1) . . . 206(n) via the communication network(s) 210, but the disclosure is not limited thereto. The FTDD 202 may also be connected to the plurality of client devices 208(1) . . . 208(2) via the communication network(s) 210, but the disclosure is not limited thereto. The database(s) 206(1) . . . 206(n) may include a rule database.

In an embodiment, the FTDD 202 is described and shown in FIG. 3 includes the FTDM 302, although it may include other rules, policies, modules, databases, or applications, for example. As will be described below, the FTDM 302 is configured to carry out a method for blocking fraudulent transactions using predictive modeling.

An exemplary system 300 for enabling a mechanism to block fraudulent transactions using predictive modeling by utilizing the network environment of FIG. 2 is shown as being executed in FIG. 3. Specifically, a first client device 208(1) and a second client device 208(2) are illustrated as being in communication with the FTDD 202. In this regard, the first client device 208(1) and the second client device 208(2) may be “clients” of the FTDD 202 and are described herein as such. Nevertheless, it is to be known and understood that the first client device 208(1) and/or the second client device 208(2) need not necessarily be “clients” of the FTDD 202, or any entity described in association therewith herein. Any additional or alternative relationship may exist between either or both of the first client device 208(1) and the second client device 208(2) and the FTDD 202, or no relationship may exist.

Further, the FTDD 202 is illustrated as being able to access one or more database(s) 206(1) . . . 206(n). The FTDM 302 may be configured to access these repositories/databases to provide a method for blocking fraudulent transactions using predictive modeling. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the FTDD 202 via broadband or cellular communication. These embodiments are merely exemplary and are not limiting or exhaustive.

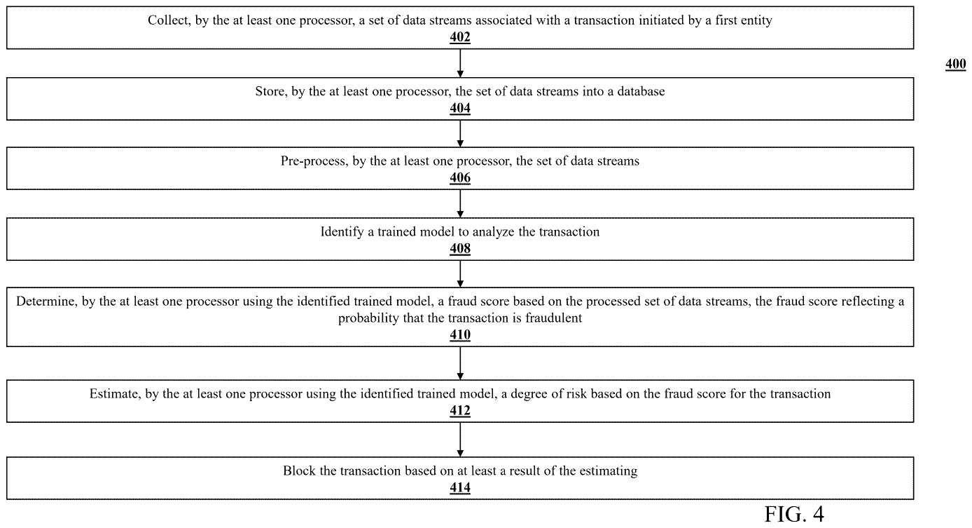

Referring to FIG. 4, an exemplary method 400 is shown for blocking fraudulent transactions using predictive modeling, in accordance with an exemplary implementation.

The method begins when an entity seeks prediction of real time fraudulent transactions. The method 400 is implemented by at least one processor 104. As used herein, entity refers to an individual (e.g., a developer) or a system which initiates at least one transaction.

At step S402, the method includes collecting, by the at least one processor 104, a set of data streams associated with a transaction initiated by a first entity. The set of data streams includes at least one from among user profile details, behavioral data, transactional data, biometrics data, communication data, contextual data, device data attributes, historical data attributes, external data attributes, anomaly detection attributes, and financial data attributes.

In an implementation, the set of data streams is received from at least one source. The at least one source may include a banking application or a platform. The set of data streams may be received using at least one from among a communication protocol and a data streaming platform. For example, the communication protocol is configured to receive the behavioral data in real time and the data streaming platform is configured to receive the biometric data and the contextual data. Biometric data refers to unique physical or behavioral characteristics used to identify or authenticate individuals. The biometric data may include fingerprint data of users (e.g., unique pattern of ridges and valleys on a user's fingertip), facial recognition data (e.g., features of a user's face such as distance between eyes, nose shape, and jawline), voice biometric data (e.g., user's voice, such as pitch, tone, cadence, and unique speech patterns), and retina data.

User profile details may include but are not limited to, a user identifier (e.g., user_1234), an account number (e.g., acc000123456789), a role of the user (e.g., corporate and joint account holder), a status of know your customer (KYC) (e.g., rejected, pending, etc.). For example, the user identifier may be collected via an application programming interface (API) which is normally stored in a core banking system and assigned during an account creation. Account numbers are collected during transactions or account queries. User roles may be queried from the user profile data using the API.

Behavioral data may include login time (e.g., login at 3:30 μm), mouse movement patterns (e.g., Path: [x=500, y=300]->[x=550, y=350]), and typing speed (e.g., 30 words per minute). For example, login time can be received in real time and is normally recorded in authentication logs when a user logs in the banking application. Mouse movement patterns are captured using JavaScript events in a banking application (hereinafter interchangeably referred to as a web browser) and coordinates of a path are sent to the at least one processor 104 during the session after the user logs in to the banking application. Typing speed refers to a measurement of time interval between two keystrokes by the first entity at the time of login into the banking application.

Transactional data may include transaction amount (e.g., 300 rupees) and merchant information (e.g., Walmart). For example, transaction data is normally captured by a payment gateway during the transaction process and is forwarded to the at least one processor 104. It is to be noted that the merchant's information is a part of the transaction process.

Communication data may include short message service (SMS) communication (e.g., SMS sent: “your balance is low”), email communication (e.g., email received: ‘password reset request’), and call logs (e.g., call from +1-555-678-1234 at 4:00 PM). Contextual data may include time of the day (e.g., morning), weather conditions (e.g., rainy), and economic indicators (e.g., unemployment rate 4.2 percent). Device data attributes may include device identifier (e.g., device_12345) and internet protocol (IP) address (e.g., device_12345). For example, whenever a user initiates a login session, the IP address is logged by a web or proxy server. Historical data attributes may include previous fraud incidents (e.g., 2024 May 1: phishing attempt), credit score history (e.g., 2024-05:750), and transaction behavior history (e.g., transaction behavior history). For example, previous fraud incidents may be retrieved via APIs which are maintained in the user's profile history. Credit score history is stored in the user profile for monitoring on an ongoing basis and is collected from credit bureaus. Transaction history is calculated based on transaction logs.

External data attributes may include social media profiles (e.g., LinkedIn: active, Instagram: active, etc.), dark web monitoring (e.g., alert: password found in breach). Anomaly detection attributes may include unexpected device change (e.g., new browser detected), and deviation from norms (e.g., transaction amount 10× larger than normal). Financial data attributes may include credit utilization (e.g., 35% of allowed credit limit) and income information (e.g., reported income $55,000 per year).

At step S404, the method includes storing, by the at least one processor 104, the set of data streams into a database. The database may be a cloud-based database and act as a first database to store unprocessed and raw data received from the set of data streams.

At step S406, the method includes pre-processing, by the at least one processor 104, the set of data streams in accordance with predefined criteria. The predefined criteria include complying the set of data streams with data cleansing process and data enrichment process, performing data encryption processes on the set of data streams, and applying predefined rules over the set of data streams for anomaly detection. In an exemplary implementation, the predefined criteria may include data aggregation and summarization.

The pre-processing of the set of data streams not only increases the reliability of the transactions but also enhances the bank's ability to offer tailored services based on enriched data insight.

Data cleansing is a process of identifying and correcting inaccuracies, inconsistencies, or missing values in the received set of data streams. This ensures that the data is accurate and reliable for analysis. The data cleansing process may include handling missing or null valued data, removing duplicate records, data normalization, data transformation, and removing duplicate records.

For example, consider a user initiating a transaction in the banking application. The user inputs their account details to make a payment. During data cleansing, the at least one processor 104 may verify that the account number is correctly formatted (e.g., ensuring it contains the correct number of digits). The at least one processor 104 may check for duplicates in the received set of data streams, such as multiple entries for the same user.

Data enrichment process involves enhancing existing data by adding relevant information from external sources. This process helps to provide more context or insights, making the data more valuable for decision-making. For example, after the user's data has been cleansed, the data enrichment process may include augmenting the user's transaction with external data sources, such as recent spending patterns, credit scores, or demographic information. It may also include analyzing the transaction against market trends to identify whether it is part of a larger spending pattern, thus helping the bank to offer personalized services (e.g., targeted promotions based on the user's spending behavior).

In an example, the predefined criteria may include data integration. The data integration may involve combining data from different sources and formats into a cohesive and unified dataset. In an example, before processing the transaction, the at least one processor 104 needs to ensure that any sensitive data is anonymized to comply with privacy regulations. Hence, the at least one processor 104 executes data encryption processes on the set of data streams to maintain user privacy.

In an exemplary implementation, applying predefined rules over the set of data streams for anomaly detection may involve creating a systematic approach to identify unusual patterns or behaviors. For example, if a transaction exceeds $1,500 but the user's average transaction amount is typically $200, flag it as suspicious. Data aggregation and summarization uses data aggregation techniques like aggregating the daily user activities to infer the peak times and the level of user engagement.

At step 408, the method includes identifying a trained model to analyze the transaction. Processor 104 compares the trained model 512 with various machine learning (ML) models to select a best model for estimating fraudulent transactions.

At step S410, the method includes determining, by the at least one processor 104 using the identified trained model, a fraud score based on the processed set of data streams, the fraud score reflecting a probability that the transaction is fraudulent.

In an exemplary implementation, the at least one trained model is a machine learning (ML) model, and the ML model is configured using machine learning algorithms.

In an exemplary implementation, training the at least one model further includes creating, by the at least one processor 104, at least one training dataset and at least one validation dataset from the processed set of data streams; and retrieving, by the at least one processor 104, a set of attributes for the at least one transaction from the at least one training dataset and the at least one validation dataset to train the at least one model.

The at least one training data set and the at least one validation data set is part of the processed data collected from the processed set of data streams and stored in the system. The at least one training dataset is fed into the at least one trained model and is randomly chosen as 80% of the processed data. The at least one validation dataset is used to validate the at least one trained model to derive the model performance and accuracy which is the remaining 20% of the dataset. In an exemplary implementation, the at least one training data set is for training the model and the at least one validation data set is fed into the at least one trained model to check its performance and accuracy.

For example, upon initiation of a transaction, the at least one processor 104 processes the incoming data streams (e.g., the set of data streams) to extract relevant features (e.g., the set of attributes) to train at least one model. The extracted features are fed into the at least one machine model that has been trained on at least one training dataset and at least one validation dataset.

In an exemplary implementation, the at least one processor 104 is configured to compute evaluation metrics for evaluation of the at least one model to ensure better performance of the selected model used for fraud detection when exposed to unknown data and finally meets all criteria and requirements of fraud detection.

The evaluation metrics may include calculation of precision score, F1 and recall score, and receiver operating characteristic (ROC) curve and area under curve (AUC). In an exemplary implementation, the at least one processor 104 may perform cross-validation against the at least one validation dataset for assessing the ability of the at least one model to be able to generalize to an independent dataset which was not part of the model training dataset.

In yet another exemplary implementation, the at least one processor 104 compares the at least one trained model with various machine learning (ML) models to select a best model for estimating fraudulent transactions.

At step S412, the method includes estimating, by the at least one processor 104 using the identified trained model, a degree of risk based on the fraud score for the at least one transaction.

For example, suppose for a fraud score 0.98, the at least tone processor 104 using the at least one trained model estimates a risk category as high risk that can cause a potential fraud. If the fraud score is 0.72, then the at least one processor 104 using the trained model estimates a risk category as medium risk. If the fraud score is 0.55, then at least one processor 104 using the trained model estimates a risk category as low risk.

At step 414, the method includes blocking the transaction based on the result of the estimating. For example, when degree of risk, either alone or in combination with other factors, indicates that the transaction is fraudulent or should be blocked, the methodology will send appropriate signals to appropriate system to prevent the transaction from being approved.

The method includes sending, by the at least one processor 104, at least one recommendation based on the estimated degree of risk to a user equipment associated with the first entity. The at least one recommendation includes at least one from among an alert corresponding to the estimated degree of risk and an actionable insight for the at least one transaction.

In an exemplary implementation, the at least one trained model utilizes fraud scoring rules to categorize transactions into four categories, namely a high risk, a medium risk, a low risk and a very low risk based on the estimated fraud score which typically represents predicted fraud probabilities that indicates the likelihood of a transaction being fraud.

The examples provided in this patent description are intended for illustrative purposes only and are not to be construed as limiting the scope of the invention. These examples are meant to demonstrate the application of the concepts and methods described herein, and variations and modifications may be made without departing from the essence of the invention.

A table representing non-limiting examples of fraud scores, degree of risk and actionable insights for the fraud scores is given below.

TABLE

| Transaction ID | Fraud Score | Risk Category | Actions Required |
|---|---|---|---|
| Txn123 | 0.98 | High Risk | Investigate/Block |
| Txn234 | 0.72 | Medium Risk | Monitor |
| Txn345 | 0.55 | Low Risk | No Action |
| Txn456 | 0.09 | Very Low Risk | No Action |

The method further includes receiving, by the at least one processor 104, a feedback in response to the at least one recommendation from at least one of: the first entity and a second entity. The received feedback may be stored in a data storage for continuous learning and training the ML model. The second entity may include an individual and fraud investigators. The feedback received on the transactions which are flagged as fraud and these feedback are easily incorporated in the at least one trained model to adjust future predictions.

The alert may include notifications related to the severity of potential fraudulent transactions. The user equipment is associated with the first entity. The user equipment may include but is not limited to, a smartphone, a tablet, a laptop, and a computer. The user equipment may view the alert on a user interface (UI). The UI may be a graphical user interface (GUI). It is to be noted that by sending alerts to the user equipment, the disclosed method flags severity of potential fraudulent transactions in a real time which helps in preemptive identification of fraud and avoids fraudulent transactions.

This way the method disclosed in the present disclosure estimates fraudulent transactions in a real time.

The above methodology provides a technical solution for the technical problems of traditional methods. The higher accuracy of the fraud detection method leads to more accurate blocking of fraudulent transactions and a corresponding reduction in false positives. By reducing the occurrence of missed fraudulent transactions and reducing false positives, the methodology avoids the corresponding expenditure of computer resources and power for corrective efforts, such that the methodology overall consumes less power and computer resources than typical methods.

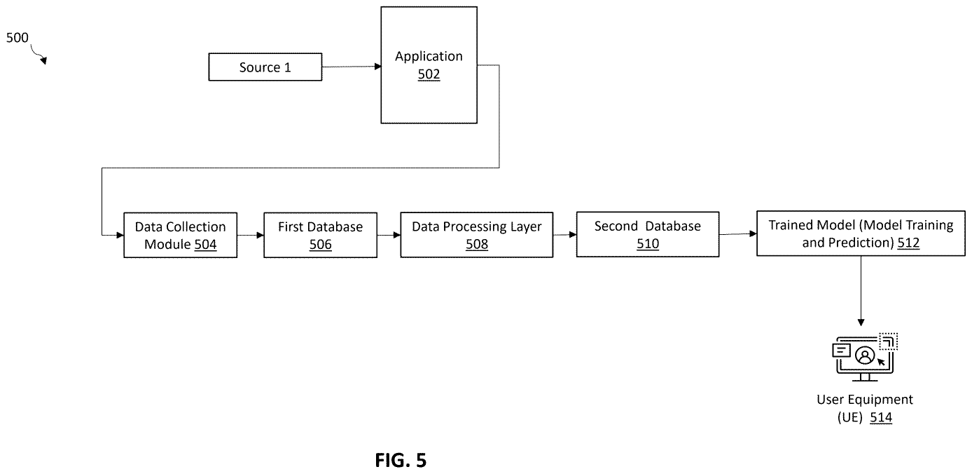

FIG. 5, illustrating a block diagram that represents a system to block fraudulent transactions using predictive modeling, in accordance with an exemplary embodiment. As illustrated in FIG. 5, the process flow 500 begins with receiving, by a data collection module 504 via an application 502 (e.g., a banking application), a set of data streams associated with at least one transaction initiated by a first entity, from at least one source (e.g., source 1: an application programming interface (API)). The application 502 may be connected with a fraud transaction detection device (FTDD) 202.

The set of data streams includes at least one from among user profile details, behavioral data, transactional data, biometrics data, communication data, contextual data, device data attributes, historical data attributes, external data attributes, anomaly detection attributes, and financial data attributes.

Further, the data collection module 504 may receive the set of data streams in real time from the application 502. The data collection module 504 may receive the set of data streams using at least one communication protocol (e.g., a web socket) and a data streaming platform (e.g., amazon kinesis). For example, the at least one communication protocol is configured to receive the behavioral data in real time and the data streaming platform is configured to receive the biometric data and the contextual data.

Further, the data collection module 504 stores the collected set of data streams into a first database 506. The first database 506 may be a cloud-based database and stores unprocessed and raw data received from the set of data streams. Further, at least one processor 104 processes the set of data streams at data processing layer 508 in accordance with predefined criteria. The predefined criteria include complying the set of data streams with data cleansing process and data enrichment process, performing data encryption processes on the set of data streams, and applying predefined rules over the set of data streams for anomaly detection. It is to be noted that the processing of the set of data streams not only increases the reliability of the transactions but also enhances the bank's ability to offer tailored services based on enriched data insight.

In an exemplary implementation, the processed set of data streams may be stored in a second database 510. Further, in order to train at least one model, the at least one processor 104 creates at least one training dataset and at least one validation dataset from the processed set of data streams.

Further, the at least one processor 104 retrieves a set of attributes for the at least one transaction from the at least one training dataset and the at least one validation dataset to train the at least one model. For example, upon initiation of a transaction, the at least one processor 104 processes the incoming data streams (e.g., the set of data streams) to extract relevant features (e.g., the set of attributes) in order to train at least one model. The extracted features are fed into the at least one machine model that has been trained on at least one training dataset and at least one validation dataset.

In another exemplary implementation, the at least one processor 104 is configured to compute evaluation metrics for evaluation of the at least one model to ensure better performance of the selected model used for fraud detection when exposed to unknown data and finally meets all criteria and requirements of fraud detection. The evaluation metrics may include calculation of precision score, F1 and recall score, and receiver operating characteristic (ROC) curve and area under curve (AUC). In an implementation, the at least one processor 104 may perform cross-validation against the at least one validation dataset for assessing the ability of the at least one model to be able to generalize to an independent dataset which was not part of the model training dataset.

In an exemplary implementation, the at least one processor 104 uses a trained model 512 to determine a fraud score based on the processed set of data streams. In an implementation, the at least one trained model 512 is a machine learning (ML) model, and the ML model is configured using machine learning algorithms. In another exemplary implementation, the at least one processor 104 compares the at least one trained model 512 with various machine learning (ML) models to select a best model for estimating fraudulent transactions. Furthermore, the at least one processor 104 using the at least one trained model 512 estimates a degree of risk based on the fraud score for the at least one transaction.

Further, the at least one processor 104 sends at least one recommendation based on the estimated degree of risk to a user equipment 514 associated with the first entity. The at least one recommendation includes at least one from among an alert corresponding to the estimated degree of risk, and an actionable insight for the at least one transaction.

In an exemplary implementation, the at least one trained model 512 utilizes fraud scoring rules to categorize transactions into four categories, namely a high risk, a medium risk, a low risk and a very low risk based on the estimated fraud score which typically includes predicted fraud probabilities that indicates the likelihood of a transaction being fraud. In one implementation, the at least one processor 104 may periodically retrain the at least one model using newly engineered features which are extracted from the incoming set of data streams. Once the at least one model is retrained, the at least one processor 104 utilizes the updated version of the at least one trained model 512. This enables the disclosed system to maintain high accuracy to combat emerging fraud patterns. For example, during holiday seasons, the user transaction patterns are expected to change considerably and the at least one model may start misclassifying normal user behavior as fraudulent. Hence the at least one processor 104 makes use of the recent holiday season data to retrain the model in order to ensure that the at least one model adapts to the seasonal change patterns without increasing the false positives. In another example, when a banking institution introduces a new payment method like cryptocurrency transactions, such payment methods are supposed to have different transaction patterns as opposed to traditional methods. Hence in such scenarios the at least one trained model 512 is retrained with the new data collected from these payment methods to decipher the new normal behavioral pattern associated with it.

In an implementation, the at least one processor 104 receives a feedback in response to the at least one recommendation from at least one of: the first entity and a second entity. The received feedback may be stored in the second database 510 for continuous learning and training of the at least one model. The second entity may include an individual and fraud investigators. The feedback received on the transactions which are flagged as fraud and these feedback are easily incorporated in the at least one trained model 512 to adjust future predictions.

The alert may include notifications related to the severity of potential fraudulent transactions. The alert sent to the user equipment 514 is associated with the first entity. The user equipment 514 may include but is not limited to, a smartphone, a tablet, a laptop, and a computer. The user equipment 514 may view the alert on a user interface (UI). The UI may be a graphical user interface (GUI). It is to be noted that by sending alerts to the user equipment 514, the disclosed system flags severity of potential fraudulent transactions in real time which helps in preemptive identification of fraud and avoids fraudulent transactions. This way the system disclosed in the present disclosure estimates fraudulent transactions using predictive modeling.

It would be appreciated by the person skilled in the art that the system offers a full-circle, adaptable, and intelligent solution for implementing a system to block fraudulent transactions using predictive modeling.

The present disclosure provides numerous advantages as given below. The disclosed method provides ability to assess transactions in real-time, allows financial institutions to respond swiftly to potential fraud, reducing the window of opportunity for fraudulent activities and protecting users more effectively. The present disclosure enhances customer trust and provides enhanced security for online transactions. The disclosed method can continuously learn and adapt to new fraud patterns as they emerge, ensuring that the fraud detection mechanism remains effective over time without requiring constant manual updates to predefined rules. The proposed method can easily scale with the growth of transaction volumes and complexity, making it suitable for large financial institutions and e-commerce platforms that handle millions of transactions daily. By generating a fraud score for each transaction, the disclosed system provides a quantifiable measure of risk that can inform automated decision-making processes, enabling more efficient resource allocation for manual reviews when necessary.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated via a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to block fraudulent transactions using predictive modeling is disclosed. The instructions include executable code which, when executed by a processor 104, may cause the processor 104 to collect a set of data streams associated with at least one transaction initiated by a first entity; store the set of data streams into a database; process the set of data streams in accordance with predefined criteria; determine, using at least one trained model, a fraud score based on the processed set of data streams; and estimate, using the at least one trained model, a degree of risk based on the fraud score for the at least one transaction.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for blocking fraudulent transactions using predictive modeling, the method being implemented by at least one processor, the method comprising:
collecting, by the at least one processor, a set of data streams associated with a transaction initiated by a first entity;
storing, by the at least one processor, the set of data streams into a database;
pre-processing, by the at least one processor, the set of data streams;
identifying a trained model to analyze the transaction;
determining, by the at least one processor using the identified trained model, a fraud score based on the processed set of data streams, the fraud score reflecting a probability that the transaction is fraudulent;
estimating, by the at least one processor using the identified trained model, a degree of risk based on the fraud score for the transaction; and
blocking the transaction based on at least a result of the estimating.

2. The method as claimed in claim 1, further comprising sending, by the at least one processor, at least one recommendation based on the estimated degree of risk to a user equipment associated with the first entity.

3. The method as claimed in claim 2, wherein the at least one recommendation comprises at least one from among an alert corresponding to the estimated degree of risk and an actionable insight for the transaction.

4. The method as claimed in claim 2, further comprising receiving, by the at least one processor, a feedback in response to the at least one recommendation from at least one of: the first entity and a second entity.

5. The method as claimed in claim 1, wherein the set of data streams comprises at least one from among user profile details, behavioral data, transactional data, biometrics data, communication data, contextual data, device data attributes, historical data attributes, external data attributes, anomaly detection attributes, and/or financial data attributes.

6. The method as claimed in claim 1, wherein the pre-processing comprises:
complying the set of data streams with data cleansing process and data enrichment process;
performing data encryption processes on the set of data streams; and
applying predefined rules over the set of data streams for anomaly detection.

7. The method as claimed in claim 1, further comprising training the identified trained model to detect a fraudulent transaction, comprising:
creating, by the at least one processor, at least one training dataset and at least one validation dataset from the set of data streams; and
retrieving, by the at least one processor, a set of attributes for the transaction from the at least one training dataset and the at least one validation dataset to train the identified trained model.

8. A computing device programed to block fraudulent transactions using predictive modeling, the computing device comprising:
a processor;
a memory storing instructions programmed to cooperate with the processor to cause the processor to perform operations comprising:
collect a set of data streams associated with a transaction initiated by a first entity;
store the set of data streams into a database;
pre-process the set of data streams;
identify a trained model to analyze the transaction;
determine, using the identified trained model, a fraud score based on the processed set of data streams, the fraud score reflecting a probability that the transaction is fraudulent;
estimate, using the trained model, a degree of risk based on the fraud score for the transaction; and
block the transaction based on at least a result of the estimating.

9. The computing device as claimed in claim 8, wherein the operations include send at least one recommendation based on the estimated degree of risk to a user equipment associated with the first entity.

10. The computing device as claimed in claim 9, wherein the at least one recommendation comprises at least one from among an alert corresponds to the estimated degree of risk and an actionable insight for the transaction.

11. The computing device as claimed in claim 9, wherein the operations include receive a feedback in response to the at least one recommendation from at least one of: the first entity and a second entity.

12. The computing device as claimed in claim 8, wherein the set of data streams comprises at least one from among user profile details, behavioral data, transactional data, biometrics data, communication data, contextual data, device data attributes, historical data attributes, external data attributes, anomaly detection attributes, and/or financial data attributes.

13. The computing device as claimed in claim 8, wherein the pre-process comprises:
complying the set of data streams with data cleansing process and data enrichment process;
performing data encryption processes on the set of data streams; and
applying predefined rules over the set of data streams for anomaly detection.

14. The computing device as claimed in claim 8, the operations further comprising training the identified trained model, comprising:
create at least one training dataset and at least one validation dataset from the set of data streams; and
retrieve a set of attributes for the transaction from the at least one training dataset and the at least one validation dataset to train the identified trained model.

15. A non-transitory computer readable storage medium storing instructions for blocking fraudulent transactions using predictive modeling, the storage medium comprising executable code which, when executed by a processor, causes the processor to perform operations comprising:
collect a set of data streams associated with a transaction initiated by a first entity;
store the set of data streams into a database;
pre-process the set of data streams;
identify a trained model to analyze the transaction;
determine, using the identified trained model, a fraud score based on the processed set of data streams, the fraud score reflecting a probability that the transaction is fraudulent;
estimate, using the identified trained model, a degree of risk based on the fraud score for the transaction; and
block the transaction based on at least a result of the estimating.

16. The storage medium as claimed in claim 15, wherein the operations include send at least one recommendation based on the estimated degree of risk to a user equipment associated with the first entity.

17. The storage medium as claimed in claim 16, wherein the at least one recommendation comprises at least one from among an alert corresponds to the estimated degree of risk and an actionable insight for the transaction.

18. The storage medium as claimed in claim 16, wherein the operations include receive a feedback in response to the at least one recommendation from at least one of: the first entity and a second entity.

19. The storage medium as claimed in claim 16, wherein the operations include receive a feedback in response to the at least one recommendation from at least one of: the first entity and a second entity.

20. The storage medium as claimed in claim 15, the set of data streams comprises at least one from among user profile details, behavioral data, transactional data, biometrics data, communication data, contextual data, device data attributes, historical data attributes, external data attributes, anomaly detection attributes, and/or financial data attributes.
